(19) United States
(12) Patent Application Publication
(10) Pub. No.: US 2022/0022161 A1
(43) Pub. Date: Jan. 20, 2022

(54) GROUPCAST FOR SIDELINK COMMUNICATION

(71) Applicant: NOKIA TECHNOLOGIES OY, Espoo (FI)

(72) Inventors: Yong Liu, Shanghai (CN); Dong Li, Shanghai (CN); Torsten Wildschek, Gloucester (GB)

(21) Appl. No.: 17/250,842

(22) PCT Filed: Sep. 28, 2018
(86) PCT No.: PCT/CN2018/108482

§ 371 Date: Mar. 11, 2021

(51) Int. Cl. H04W 72/00; H04W 4/40; H04W 4/08

(52) U.S. Cl. CPC H04W 72/005; H04W 4/08; H04W 4/40

(57) ABSTRACT

Embodiments of the present disclosure relate to methods, devices, apparatuses and computer readable storage medium of groupcast for sidelink communication. In example embodiments, at a leader device in a group of devices, an orthogonal sequence and cover code is selected from a first set of orthogonal sequences and a first set of orthogonal cover codes. The first set of orthogonal sequences and the first set of orthogonal cover codes are used for acknowledgement feedback in the group. An indication of the selected orthogonal sequence and cover code is sent to a first member device of a plurality of member devices in the group.

### FIELD

Embodiments of the present disclosure generally relate to the field of communications, and in particular, to methods, devices, apparatuses and computer readable storage medium of groupcast for sidelink communication.

### BACKGROUND

The New Radio (NR) Vehicle-to-everything (V2X) technology supports advanced V2X services which may be categorized into four use case groups: vehicles platooning, extended sensors, advanced driving and remote driving. Vehicle platooning is a typical scenario where groupcast data traffic arises and is abundant. A platoon includes a platoon leader and multiple members. Two types of groupcast communications are involved in the platoon: the leader groupcasting to the members and each member groupcasting to the leader and other members. A scheme of acknowledgement feedback, such as acknowledgement/non-acknowledgement (ACK/NACK) feedback is needed to enable groupcast in NR V2X sidelink.

### SUMMARY

In general, example embodiments of the present disclosure provide methods, devices, apparatuses and computer readable storage medium of groupcast for sidelink communication.

In a first aspect, a method is provided. In the method, at a leader device in a group of devices, an orthogonal sequence and cover code is selected from a first set of orthogonal sequences and a first set of orthogonal cover codes. The first set of orthogonal sequences and the first set of orthogonal cover codes are used for acknowledgement feedback in the group. An indication of the selected orthogonal sequence and cover code is sent to a first member device of a plurality of member devices in the group.

In a second aspect, a method is provided. In the method, at a member device in a group of devices, an indication of an orthogonal sequence and cover code from a first set of orthogonal sequences and a first set of orthogonal cover codes is received from a leader device in the group. The first set of orthogonal sequences and the first set of orthogonal cover codes are used for acknowledgement feedback in the group. Upon decoding a packet groupcast in the group, a positive acknowledgement is sent for the packet using the orthogonal sequence and cover code.

In a third aspect, a device is provided at least one processor and at least one memory including computer program code. The at least one memory and the computer program code are configured to, with the at least one processor, cause the device to perform the method according to the first or second aspect.

In a fourth aspect, there is provided an apparatus comprising means for performing the method according to the first or second aspect.

In a fifth aspect, there is provided a computer readable storage medium that stores a computer program thereon. The computer program, when executed by a processor of a device, causes the device to perform the method according to the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which embodiments of the present disclosure can be implemented;

FIG. 2 illustrates an example time-domain structure of a control channel for acknowledgement feedback in accordance with some embodiments of the present disclosure;

FIG. 3 illustrates example Frequency Division Multiplexing (FDM) of the control channel for acknowledgement feedback and the PSSCH and PSCCH in accordance with some embodiment of the present disclosure;

FIG. 4 illustrates an example process for Code Division Multiplexing (CDM) of acknowledgement feedback from multiple devices 120 in accordance with some embodiments of the present disclosure;

FIG. 5 illustrates an example process for CDM of acknowledgement feedback from multiple devices 120 in accordance with some other embodiments of the present disclosure;

FIG. 6 illustrates an example process of assigning CDM signatures in accordance with some embodiments of the present disclosure;

FIG. 7 illustrates an example process of retransmission in a group in accordance with some embodiments of the present disclosure;

FIG. 8 illustrates an example scenario of location-based selective retransmission in a group in accordance with some embodiments of the present disclosure;

FIG. 9 illustrates a flowchart of an example method in accordance with some embodiments of the present disclosure;

FIG. 10 illustrates a flowchart of an example method in accordance with some other embodiments of the present disclosure; and

FIG. 11 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “device” refers to any suitable device enables Device to Device (D2D), Vehicle to Vehicle (V2V) or V2X communication. Examples of the communication device include user equipment (UE) such as smart phones, wireless-enabled tablet computers, laptop-embedded equipment (LEE), laptop-mounted equipment (LME), and/or wireless customer-premises equipment (CPE).

As used herein, the term “circuitry” may refer to one or more or all of the following:

(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Schemes for ACK/NACK feedback are being discussed to efficiently enable groupcast in NR V2X sidelink. NR V2X sidelink communication is specified in the 3rd Generation Partnership Project (3GPP) to be performed in a groupcast mode at a physical (PHY) layer. Accordingly, Hybrid Automatic Repeat reQuest (HARQ) at the PHY layer requires a receiver to feed ACK/NACK back to a transmitter. In Long Term Evolution (LTE) V2X, only the broadcast mode is specified at a physical (PHY) layer for sidelink communications. The groupcast mode is only allowed at higher layers.

In addition, for the groupcast communication in NR V2X sidelink, multiple receiving user equipment (UEs) are involved in this feedback procedure. It is a critical issue to coordinate feedbacks from multiple receiving UEs. Thus, the feedback design is complicated in this scenario.

Embodiments of the present disclosure provide resource efficient schemes of ACK/NACK feedback and retransmission for groupcast communications in sidelink. With the schemes, a leader device in a group of devices allocates an orthogonal sequence and cover code to each member device in the group. The orthogonal sequence and cover code are respectively selected from a set of orthogonal sequences and a set of orthogonal cover codes used for acknowledgement to a packet groupcast in the group. Accordingly, the individual devices in the group can use the respective orthogonal sequences and orthogonal cover codes to feed acknowledgements back.

FIG. 1 illustrates an example environment 100 in which embodiments of the present disclosure can be implemented. In this example, as shown, the environment 100 is a section of highway. It is to be understood that this is only for the purpose of illustration, without suggesting any limitation. The environment 100 may be any suitable indoor or outdoor environment.

The environment 100, which may be a part of a communication network, comprises a group 110 of devices, including devices 120-1, 120-2 . . . 120-n (collectively referred to as a member device 120), where n represents any suitable positive integer. In this example, the devices 120 are communication devices mounted on the vehicles driving on the highway. The group 110 includes a leader device (for example, the device 120-4) and multiple member devices (for example, the device 120-1, 120-2, 120-3, 120-5 . . . 120-n). The leader device may be elected in the group 100 in any suitable way. The scope of the present disclosure will not be limited in this regard.

The devices 120 can communicate with each other. The communications may follow any suitable communication standards or protocols such as Universal Mobile Telecommunications System (UMTS), long term evolution (LTE), LTE-Advanced (LTE-A), the fifth generation (5G) NR, Wireless Fidelity (Wi-Fi) and Worldwide Interoperability for Microwave Access (WiMAX) standards. The communications may employ any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC) and ultra-reliable low latency communication (URLLC) technologies.

In various embodiments, the devices 120 can groupcast in the group 110 using Device to Device (D2D), Vehicle to Vehicle (V2V) or V2X communication technologies. The devices 120 can feed acknowledgements back for a packet groupcast in the group 110.

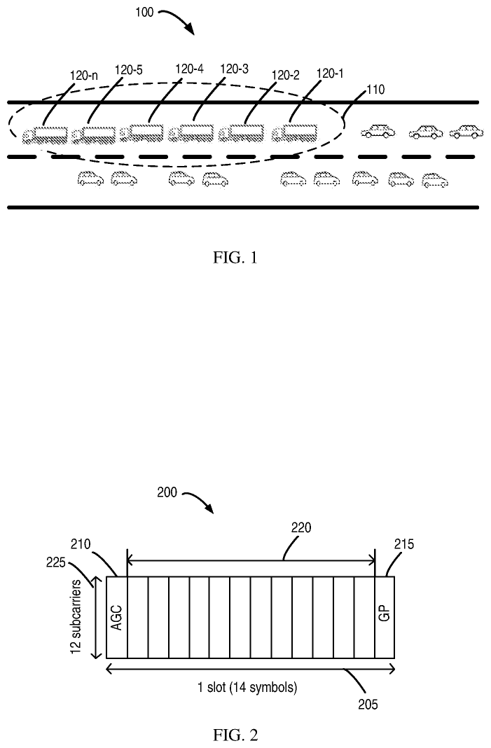

The acknowledgement, such as ACK/NACK, may be transmitted on a control channel in the PHY layer. FIG. 2 illustrates an example structure of a control channel 200 for acknowledgement feedback in accordance with some embodiments of the present disclosure. As shown, the control channel 200 occupies a slot 205 in a time domain. In this example, the slot 205 includes 14 OFDM symbols. Among the 14 symbols, the first symbol 210 may be used for automatic gain control (AGC). AGC is performed at the beginning of each channel to adjust an input to an analog-to-digital converter (ADC). The last symbol 215 may be used as a guard symbol to reserve a gap (GP). The middle 12 symbols 220 are used to carry ACK/NACK information. The receiving signal strength may remain roughly constant throughout the channel.

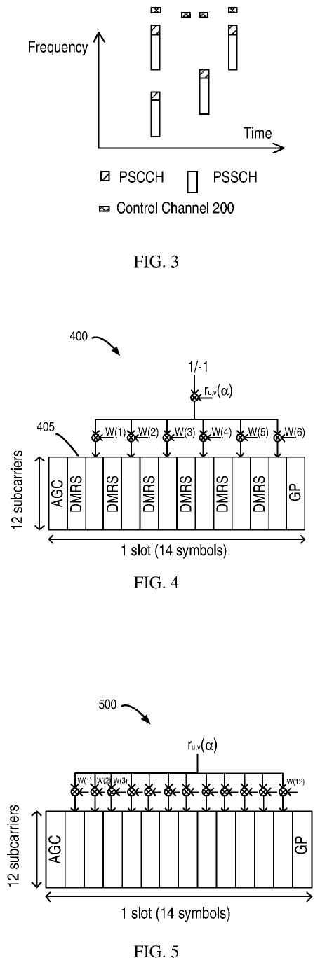

For Physical Sidelink Shared Channel (PSSCH) and Physical Sidelink Control Channel (PSCCH) in LTE V2V, the basic (minimum) resource unit in the time domain is a slot (or sub-frame). Thus, the control channel 200 may be flexibly multiplexed in frequency domain (or FDMed) with the PSSCH and PSCCH, as shown in FIG. 3 which illustrates example Frequency Division Multiplexing (FDM) of the control channel 200 and the PSSCH and PSCCH in accordance with some embodiment of the present disclosure.

In the frequency domain, the control channel 200 may occupy one physical resource block (PRB) 225, including 12 subcarriers, which is the minimum resource unit in a frequency domain. As an alternative example, the control channel 200 may occupy 2 PRBs. In LTE V2V, the size of only a PSCCH (for scheduling assignment) is specified to be 2 PRBs. Thus, the control channel 200 with 2 PRBs may get aligned with the PSCCH for flexible multiplexing and resource allocation of both the channels in a common resource pool in the frequency domain. For NR V2V, a control channel for scheduling assignment may be redesigned, and 1 PRB may also be adopted.

The resource may be selected by a groupcasting device (or transmitter, either a leader device or a member device) from a set of resources predefined at a network side. As an example, together with data (for example, on PSSCH), the transmitter may also append the information on the feedback resource to indicate where receiving UEs should feedback ACK/NACK. As another example, the information on the feedback resource is included in the PSCCH. Alternatively, the information on the feedback resource may be implicitly derived from a resource location of either PSCCH or PSSCH.

Still with reference to FIG. 1, the leader device (for example, the device 120-4) allocates an orthogonal sequence and cover code to each member device in the group 110, from a set of orthogonal sequences and a set of orthogonal cover codes that are used for acknowledgement feedback in the group 110. Accordingly, the individual devices 120 can use the respective orthogonal sequences and orthogonal cover codes for acknowledgement feedback. In this way, the ACK/NACK information from multiple devices 120 can be multiplexed in the code domain (CDMed). Since the ACK/NACK information (1 bit from a device) carried in the minimum resource unit is very limited, Code Division Multiplexing (CDM) may increase resource efficiency.

FIG. 4 illustrates an example process 400 for CDM of acknowledgement feedback from multiple devices 120 in accordance with some embodiments of the present disclosure.

In this example, the orthogonal sequences are generated based on a Zadoff-Chu sequence (as a base sequence) with different cyclic shifts. The orthogonal cover codes (OOC) are implemented by Discrete Fourier Transform (DFT) sequences of length 6. Other implementations of the orthogonal cover codes are possible. In addition, Binary Phase Shift Keying (BPSK) modulation is used. Accordingly, the modulated symbol is spread with a Zadoff-Chu sequence (cyclic shifted) with OCCs in the time domain.

As shown in FIG. 4, r_{u,v} represents a Zadoff-Chu sequence, a represents a cyclic shift, and W(1)˜W(6) represent OCCs. The acknowledgement comprises a positive acknowledgement (or ACK) and a negative acknowledgement (or NACK), represented by 1 or −1. For the acknowledgement of each device 120, a demodulation reference signal (DMRS) 405 is transmitted together with the acknowledgement.

FIG. 5 illustrates another example process 500 for Code Division Multiplexing of acknowledgement feedback from multiple devices 120 in accordance with some other embodiments of the present disclosure.

In this example, only a positive acknowledgement (or ACK) is transmitted. In this way, as shown, more (for example, double) devices can be CDMed in the channel. In addition, aggregated signal strength of the channel is lower, which brings less interference (IBI) to other FDMed channels.

In some embodiments, all devices 120 in the group 110 use the same Zadoff-Chu sequence as a base sequence. The leader device may determine a group-specific CDM signature for this group. Each device 120 in the group 110 is assigned to a CDM signature (device-specific) which is a combination of a cyclic shift (CS) and an OCC. The CDM signatures for the group 110 are orthogonal. In the specified resource, the devices 120 use their specific CDM signatures to feedback ACK/NACK information simultaneously. For the control channel 200 carrying only ACK information as shown in FIG. 5, the presence of device-specific CDM signature in this control channel indicates ACK from the respective device 120 in this group 110.

In some embodiments, adjacent groups may use the same Zadoff-Chu sequence as the base sequence. The adjacent groups may have different group-specific CDM signatures. Device-specific CDM signatures of all devices in adjacent groups may be orthogonal. For example, the sets of device-specific CDM signatures in adjacent groups are orthogonal. As such, mutual interferences may be reduced if the devices in adjacent groups choose the same time and/or frequency resource to feedback ACK/NACK simultaneously.

For a Zadoff-Chu sequence, group-specific CDM signatures are limited. In some embodiments, adjacent groups may use different base sequences with lower mutual correlations.

In some embodiments, the orthogonal sequence and cover code allocated to a device 120 may be associated with a device identifier (ID) of the device IDs within the group 110. Table 1 and Table 2 show example associations predefined in two adjacent groups.

TABLE 1

| ID | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| CS | 0 | 2 | 4 | 6 | 8 | 10 | 0 | 2 | 4 | 6 | 8 | 10 | 0 | 2 | 4 | 6 | 8 | 10 |
| OCC | W1 | W1 | W1 | W1 | W1 | W1 | W2 | W2 | W2 | W2 | W2 | W2 | W3 | W3 | W3 | W3 | W3 | W3 |

TABLE 2

| ID | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| CS | 0 | 2 | 4 | 6 | 8 | 10 | 0 | 2 | 4 | 6 | 8 | 10 | 0 | 2 | 4 | 6 | 8 | 10 |
| OCC | W4 | W4 | W4 | W4 | W4 | W4 | W5 | W5 | W5 | W5 | W5 | W5 | W6 | W6 | W6 | W6 | W6 | W6 |

In the above two tables, for a sequence, a CDM signature is represented by a cyclic shift α, and OCC wᵢ (i=1, . . . , 6) which are ordered orthogonal codes. The associations may be predefined or configured dynamically. Using the associations, the device-specific CDM signatures may be derived from the group-specific CDM signature and the local device ID.

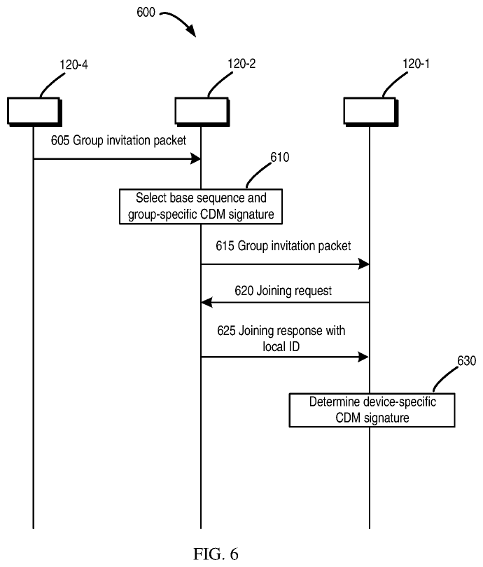

The allocation of the orthogonal sequence and cover code may be performed upon a joining request from a member device. FIG. 6 illustrates an example process 600 of assigning CDM signatures in accordance with some embodiments of the present disclosure.

In the process 600, the device 120-4 (as a leader device) in the group 110 broadcasts (605) the information on the base sequence and group-specific CDM signature (the set of orthogonal sequences or/and the set of orthogonal cover codes) used by the group 110. The information may be carried in a group invitation packet periodically announced. When the device 120-2 tries to find a group, the device 120-2 first checks a group invitation packet. If there is no suitable group to join, the device 120-2 initiates a new group and acts as a leader device of the new group. Based on the base sequences and the group-specific CDM signatures used by adjacent groups, the device 120-2 selects (610) a suitable base sequence and group-specific CDM signature. The device 120-2 may select the same base sequence as the detected adjacent group and an unused group-specific CDM signature. Alternatively, the device 120-2 selects a base sequence different from that of the adjacent group.

The device 120-2 broadcasts (615) (for example, periodically) a group invitation packet including the information on the base sequence and group-specific CDM signature. When the device 120-1 wants to join the group organized by the device 120-2, the device 120-1 sends (620) a joining request to the device 120-2. The device 120-2 sends (625) to the device 120-1 a joining response including an assigned device ID to indicate the allocated orthogonal sequence and cover code. The assignment of local device IDs may be sequential. For example, the leader device (for example, the device 120-2) assigns smallest available local device ID to a joining device. After a device left the group, its local device ID may be released. The device 120-1 determines (630) the device-specific CDM signature from the assigned local device ID and the group-specific CDM signature broadcast by the device 120-2.

With the orthogonal sequences and orthogonal cover codes allocated by the leader device, the devices 120 may feed acknowledgements back after decoding a packet groupcast in the group 110. Accordingly, the transmitter (either a leader device or a member device) may detect an acknowledgement (for example, a positive acknowledgement or ACK) based on the respective orthogonal sequences and orthogonal cover codes. The transmitter may decide whether to retransmit the message based on the detected acknowledgements.

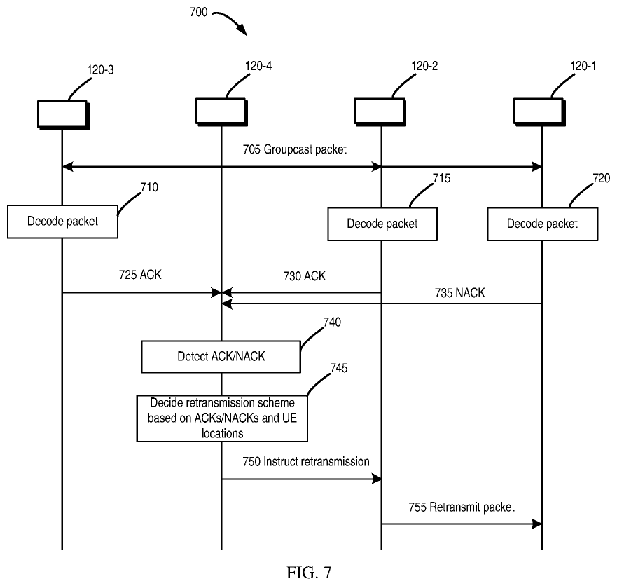

FIG. 7 illustrates an example process 700 of retransmission in the group 110 in accordance with some embodiments of the present disclosure.

In the process 700, the device 120-4 (for example, as the leader device in the group 110) groupcasts (705) a packet in the group 110. The devices 120-1, 120-2 and 120-3 (for example, as the member devices) try to decode the packet (710, 715, 720). In the assigned feedback resource, the devices 120-1, 120-2 and 120-3 feed ACK/NACK information back by using device-specific CDM signatures (725, 730, 735). As an alternative example, in the assigned feedback resource, only the devices which correctly decode the packet feed the ACK information back by using device-specific CDM signatures.

At the transmitter side, the device 120-4 detects (740) ACK/NACK information based on the device-specific CDM signatures (modulated bit). If both ACKs/NACKs are fed back, from detected device-specific CDM signatures (modulated bit), the device 120-4 may identify two sets of devices: the set of devices feeding-back ACKs and the set of devices feeding-back NACKs. Alternatively, if only ACKs are fed back, from detected device-specific CDM signatures, the leader device may identify only the set of devices feeding ACKs back.

Based on the feedback, the device 120-4 may determine whether to cause the packet to be retransmitted. For example, if the number of devices feeding ACKs back is below a threshold number, the packet may be retransmitted. The threshold number may be any suitable number. As an example, the threshold number may be the total number of devices in the group minus one.

In some embodiments, the leader device may broadcast (for example, periodically) the number of devices in the group so that all the member devices are aware of this information. Accordingly, when a member device groupcasts a packet, the member device may determine whether to retransmit based on the number of devices in the group. After a group forms, the group is quite stable for a long time, and hence the number of devices in the group will not change frequently.

If a device fails decoding the packet, the retransmission of the packet may allow the device to employ HARQ to decode the packet again. In some embodiments, the transmitter may groupcast the packet again in the group.

In some other embodiments, location-based selective retransmission may be employed. For example, the device ID may be associated with the location of the device. The device may broadcast the association. For example, the device ID may be included in a basic safety packet (including location, speed, direction, and the like) broadcast by the device to enable several vehicle applications, such as safety, autonomous driving, and the like. If the transmitter knows the associations between the locations and the device-specific CDM signatures, the transmitter may instruct the location-based selective retransmission. For example, the transmitter may inform a device UE (from which ACK is detected) to retransmit the packet to a nearby device (from which ACK is not detected).

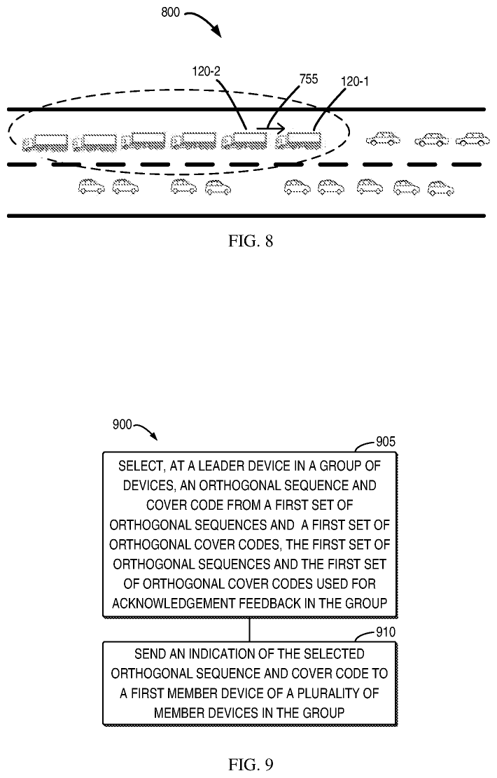

As shown in FIG. 7, the device 120-4 decides (745) the retransmission scheme based on ACKs/NACKs and the locations of the member devices. In this example, the leader device determines that the device 120-2 retransmits the packet to the device 120-1. Then, the device 120-4 instructs (750) the device 120-2 to retransmit the packet to the device 120-1. The device 120-2 retransmits (755) the packet to the device 120-1, as shown in FIG. 8 which illustrates an example scenario 800 of location-based selective retransmission in a group in accordance with some embodiments of the present disclosure.

The location based selective retransmission is particularly useful for large volume data transmission at mmWave band. In the scenario of driving in the highway, transmissions are more directional or easily blocked by vehicles in the middle. It's more efficient to cause an intermediate device to relay the packet.

The process 700 of retransmission repeats until the transmitter receives ACKs from all other devices in the group or until the number of retransmissions reaches a threshold number.

FIG. 9 illustrates a flowchart of an example method 900 in accordance with some embodiments of the present disclosure. The method 900 can be implemented by the leader device in the group 110 as shown in FIG. 1.

At block 905, at a leader device in a group of devices, an orthogonal sequence and cover code is selected from a first set of orthogonal sequences and from a first set of orthogonal cover codes. The first set of orthogonal sequences and the first set of orthogonal cover codes are used for acknowledgement feedback in the group.

At block 910, an indication of the selected orthogonal sequence and cover code is sent to a member device (referred to as a first member device) of a plurality of member devices in the group.

In some embodiments, the selected orthogonal sequence and cover code may be associated with a first device identifier from a plurality of device identifiers for the group. The first device identifier may be sent as the indication to the first member device.

In some embodiments, the orthogonal sequence and cover code may be selected in response to a joining request from the first member device.

In some embodiments, a second set of orthogonal sequences and a second set of orthogonal cover codes may be determined to be used by an adjacent group. The first set of orthogonal sequences and the first set of orthogonal cover codes may be determined based on the second set of orthogonal sequences and the second set of orthogonal cover codes.

In some embodiments, the first set of orthogonal cover codes may be different from the second set of orthogonal cover codes or/and the first set of orthogonal sequences is different from the second set of orthogonal sequences.

In some embodiments, the first set of orthogonal sequences or/and the first set of orthogonal cover codes may be broadcast.

In some embodiments, a packet may be groupcast in the group. Then, from the plurality of member devices, a plurality of positive acknowledgements for the packet may be detected based on the first set of orthogonal sequences and the first set of orthogonal cover codes.

In some embodiments, the plurality of positive acknowledgements may be detected in time and frequency resources for the group, the time and frequency resources comprising a time slot in a time domain and at least one physical resource block in a frequency domain.

In some embodiments, it may be determined whether the number of positive acknowledgements is below a threshold number. If the number of positive acknowledgements is below the threshold number, the packet may be caused to be retransmitted in the group.

In some embodiments, the packet may be groupcast again in the group.

In some embodiments, a first set of member devices and a second set of member devices may be determined from the plurality of member devices, wherein a positive acknowledgement is detected from each device in the first set of member devices. A second member device may be selected from the first set of member devices based on a plurality of locations of the plurality of member devices. The second member device may be instructed to retransmit the packet to the second set of member devices.

In some embodiments, the plurality of locations may be determined based on a plurality of associations between a plurality of device identifiers of the plurality of member devices and the plurality of locations.

In some embodiments, the plurality of associations may be received from the plurality of member devices.

In some embodiments, an association between a second device identifier of the leader device from a set of device identifiers for the group and a location of the leader device may be broadcast.

In some embodiments, a basic safety packet containing the second device identifier may be broadcast.

In some embodiments, the number of devices of the group may be groupcast in the group.

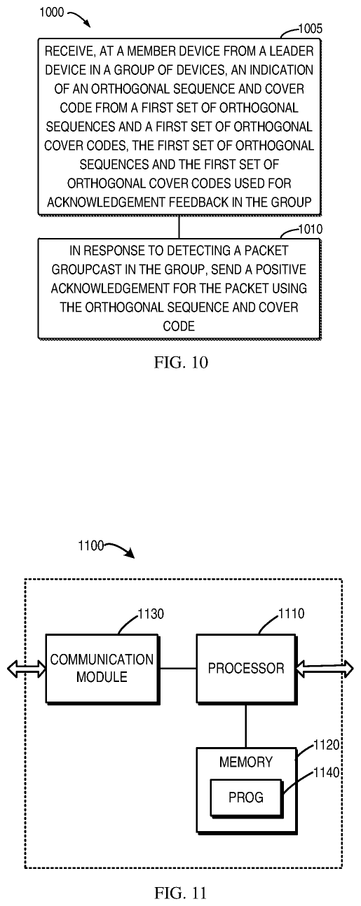

FIG. 10 illustrates a flowchart of an example method 1000 in accordance with some embodiments of the present disclosure. The method 1000 can be implemented by the member device in the group 110 as shown in FIG. 1.

At block 1005, at a member device in a group of devices, an indication of an orthogonal sequence and cover code from a first set of orthogonal sequences and from a first set of orthogonal cover codes are received from a leader device in the group. The first set of orthogonal sequences and the first set of orthogonal cover codes are used for acknowledgement feedback in the group.

At block 1010, in response to detecting a packet groupcast in the group, a positive acknowledgement for the packet is sent using the orthogonal sequence and cover code.

In some embodiments, the orthogonal sequence and cover code may be associated with a first device identifier from a plurality of device identifiers for the group.

In some embodiments, the first device identifier may be received as the indication from the leader device.

In some embodiments, an association of the first device identifier and a location of the member device may be broadcast.

In some embodiments, a basic safety packet containing the device identifier may be broadcast.

In some embodiments, in response to detecting the packet, the positive acknowledgement is sent in time and frequency resources for the group, the time and frequency resources comprising a time slot in a time domain and at least one physical resource block in a frequency domain.

In some embodiments, a joining request is sent to the leader device.

In some embodiments, the first set of orthogonal sequences or/and the first set of orthogonal cover codes broadcast by the leader device is received.

In some embodiments, a packet may be groupcast in the group. Then, from the plurality of member devices, a plurality of positive acknowledgements for the packet may be detected based on the first set of orthogonal sequences and the first set of orthogonal cover codes.

In some embodiments, the plurality of positive acknowledgements may be detected in time and frequency resources for the group, the time and frequency resources comprising a time slot in a time domain and at least one physical resource block in a frequency domain.

In some embodiments, it may be determined whether the number of positive acknowledgements is below a threshold number. If the number of positive acknowledgements is below the threshold number, the packet may be caused to be retransmitted in the group.

In some embodiments, the packet may be groupcast again in the group.

In some embodiments, a first set of devices and a second set of devices may be determined from other devices in the group, wherein a positive acknowledgement is detected from each device in the first set of devices. A device may be selected from the first set of devices based on locations of other devices in the group. The selected device may be instructed to retransmit the packet to the second set of devices.

In some embodiments, the locations may be determined based on associations between the locations and device identifiers of other devices in the group.

In some embodiments, the associations may be received from other devices in the group.

In some embodiments, the number of devices of the group groupcast by the leader device may be received.

All operations and features as described above with reference to FIGS. 1-8 are likewise applicable to the methods 900 and 1000 and have similar effects. For the purpose of simplification, the details will be omitted.

In some embodiments, an apparatus capable of performing the methods 900 and 1000 may comprise means for performing the respective steps of the methods 900 and 1000. The means may be implemented in any suitable form. For example, the means may be implemented in a circuitry or software module.

FIG. 11 is a simplified block diagram of a device 1100 that is suitable for implementing embodiments of the present disclosure. The device 1100 can be implemented at or at least as a part of the leader device or the member device in the group 110 as shown in FIG. 1.

As shown, the device 1100 includes a processor 1110, a memory 1120 coupled to the processor 1110, a communication module 1130 coupled to the processor 1110, and a communication interface (not shown) coupled to the communication module 1130. The memory 1120 stores at least a program 1140. The communication module 1130 is for bidirectional communications. The communication interface may represent any interface that is necessary for communication.

The program 1140 is assumed to include program instructions that, when executed by the associated processor 1110, enable the device 1100 to operate in accordance with the embodiments of the present disclosure, as discussed herein with reference to FIGS. 3-11. The embodiments herein may be implemented by computer software executable by the processor 1110 of the device 1100, or by hardware, or by a combination of software and hardware. The processor 1110 may be configured to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

All operations and features as described above with reference to FIGS. 1-10 are likewise applicable to the device 1100 and have similar effects. For the purpose of simplification, the details will be omitted.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 900 and 1000 as described above with reference to FIGS. 1-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various embodiments of the techniques have been described. In addition to or as an alternative to the above, the following examples are described. The features described in any of the following examples may be utilized with any of the other examples described herein.

1-38. (canceled)

39. An apparatus comprising:
at least one processor; and
at least one memory including computer program code,
the at least one memory and the computer program code configured to, with the at least one processor, cause the apparatus at least to:
select, at a leader device in a group of devices, an orthogonal sequence and cover code from a first set of orthogonal sequences and a first set of orthogonal cover codes, the first set of orthogonal sequences and the first set of orthogonal cover codes used for acknowledgement feedback in the group; and
send an indication of the selected orthogonal sequence and cover code to a first member device of a plurality of member devices in the group.

40. The apparatus of claim 39, wherein the selected orthogonal sequence and cover code are associated with a first device identifier from a plurality of device identifiers for the group, and the computer program code configured to, with the at least one processor, cause the apparatus to send comprises the computer program code configured to, with the at least one processor, cause the apparatus to:
send the first device identifier as the indication to the first member device.

41. The apparatus of claim 39, wherein the computer program code configured to, with the at least one processor, cause the apparatus to select the orthogonal sequence and cover code comprises the computer program code configured to, with the at least one processor, cause the apparatus to:
in response to a joining request from the first member device, select the orthogonal sequence and cover code.

42. The apparatus of claim 39, wherein the at least one memory and the computer program code configured to, with the at least one processor, further cause the apparatus at least to:
determine a second set of orthogonal sequences and a second set of orthogonal cover codes used by an adjacent group; and
determine the first set of orthogonal sequences and the first set of orthogonal cover codes based on the second set of orthogonal sequences and the second set of orthogonal cover codes.

43. The apparatus of claim 39, wherein the at least one memory and the computer program code configured to, with the at least one processor, further cause the apparatus at least to:
groupcast a packet in the group; and
detect, from the plurality of member devices, a plurality of positive acknowledgements for the packet based on the first set of orthogonal sequences and the first set of orthogonal cover codes.

44. The apparatus of claim 43, wherein the at least one memory and the computer program code configured to, with the at least one processor, further cause the apparatus at least to:
determine whether the number of positive acknowledgements is below a threshold number; and
in response to determining that the number of positive acknowledgements is below the threshold number, cause the packet to be retransmitted in the group.

45. The apparatus of claim 44, wherein the at least one memory and the computer program code configured to, with the at least one processor, cause the packet to be retransmitted comprises the at least one memory and the computer program code configured to, with the at least one processor, cause the apparatus to:
determine a first set of member devices and a second set of member devices from the plurality of member devices, wherein a positive acknowledgement is detected from each device in the first set of member devices;
select a second member device from the first set of member devices based on a plurality of locations of the plurality of member devices; and
instruct the second member device to retransmit the packet to the second set of member devices.

46. The apparatus of claim 45, wherein the at least one memory and the computer program code configured to, with the at least one processor, cause the packet to be retransmitted comprises the at least one memory and the computer program code configured to, with the at least one processor, further cause the apparatus to:
determine the plurality of locations based on a plurality of associations between a plurality of device identifiers of the plurality of member devices and the plurality of locations.

47. An apparatus comprising:
at least one processor; and
at least one memory including computer program code,
the at least one memory and the computer program code configured to, with the at least one processor, cause the apparatus at least to:
receive, at a member device from a leader device in a group of devices, an indication of an orthogonal sequence and cover code from a first set of orthogonal sequences and a first set of orthogonal cover codes, the first set of orthogonal sequences and the first set of orthogonal cover codes used for acknowledgement feedback in the group; and
in response to detecting a packet groupcast in the group, send a positive acknowledgement for the packet using the orthogonal sequence and cover code.

48. The apparatus of claim 47, wherein the orthogonal sequence and cover code are associated with a first device identifier from a plurality of device identifiers for the group.

49. The apparatus of claim 47, wherein the at least one memory and the computer program code configured to, with the at least one processor, cause the apparatus to receive the indication comprises the at least one memory and the computer program code configured to, with the at least one processor, cause the apparatus to:
receive the first device identifier as the indication from the leader device.

50. The apparatus of claim 47, wherein the at least one memory and the computer program code are configured to, with the at least one processor, further cause the apparatus to:
broadcast an association of the first device identifier and a location of the member device.

51. The apparatus of claim 47, wherein the at least one memory and the computer program code configured to, with the at least one processor, cause the apparatus to send the positive acknowledgement comprises the at least one memory and the computer program code configured to, with the at least one processor, cause the apparatus to:
in response to detecting the packet, send the positive acknowledgement in time and frequency resources for the group, the time and frequency resources comprising a time slot in a time domain and at least one physical resource block in a frequency domain.

52. The apparatus of claim 47, wherein the at least one memory and the computer program code are configured to, with the at least one processor, further cause the apparatus to:
send a joining request to the leader device.

53. The apparatus of claim 47, wherein the at least one memory and the computer program code are configured to, with the at least one processor, further cause the apparatus to:
receive at least one of the first set of orthogonal sequences and the first set of orthogonal cover codes broadcast by the leader device.

54. The apparatus of claim 47, wherein the at least one memory and the computer program code are configured to, with the at least one processor, further cause the apparatus to:
groupcast a packet in the group; and
detect, from other devices in the group, a plurality of positive acknowledgements for the packet based on the first set of orthogonal sequences and the first set of orthogonal cover codes.

55. The apparatus of claim 54, wherein the at least one memory and the computer program code are configured to, with the at least one processor, further cause the apparatus to:
determine whether the number of positive acknowledgements is below a threshold number; and
in response to determining that the number of positive acknowledgements is below the threshold number, cause the packet to be retransmitted within the group.

56. The apparatus of claim 55, wherein the at least one memory and the computer program code configured to, with the at least one processor, cause the packet to be retransmitted comprises the at least one memory and the computer program code configured to, with the at least one processor, cause the apparatus to:
determine a first set of devices and a second set of devices from other devices in the group, wherein a positive acknowledgement is detected from each device in the first set of devices;
select a device from the first set of devices based on locations of other devices in the group; and
instruct the selected device to retransmit the packet to the second set of devices.

57. The apparatus of claim 56, wherein the at least one memory and the computer program code configured to, with the at least one processor, cause the packet to be retransmitted comprises the at least one memory and the computer program code configured to, with the at least one processor, further cause the apparatus to:
determine the locations based on associations between the locations and device identifiers of other devices in the group.

58. The apparatus of claim 57, wherein the at least one memory and the computer program code configured to, with the at least one processor, cause the packet to be retransmitted comprises the at least one memory and the computer program code configured to, with the at least one processor, further cause the apparatus to:
receive the associations from other devices in the group.
